(19) United States
(12) Patent Application Publication
(10) Pub. No.: US 2001/0033221 A1
(43) Pub. Date: Oct. 25, 2001

(54) Passive optical identification system

(76) Inventors: Michael A. Thomas, Grand Blanc, MI (US); Patrick A. Banas, Sterling Heights, MI (US)

Correspondence Address: Anthony P. Cho, Carlson, Gaskey & Olds, P.C., Ste. 350, 400 W. Maple Rd., Birmingham, MI, 48009, US

(21) Appl. No.: 09/794,459

(22) Filed: Feb. 27, 2001

Related U.S. Application Data
(60) Provisional application No. 60/186,643, filed on Mar. 2, 2000.

(51) Int. Cl. H04Q 1/00; H04B 1/00; G05B 19/00

(52) U.S. Cl. 340/5.61; 359/113; 359/168

(57) ABSTRACT

The electronic security system comprises two sets of transmitters and receivers. A first transmitter generates an energy carrying signal for a first receiver in communication with the first transmitter. A memory unit is at least partially powered by the energy carrying signal received by the first receiver. The memory unit stores a key code and a second transmitter in communication with the memory unit generates a key code carrying signal. A second receiver in communication with the second transmitter receives the key code carrying signal. The energy carrying signal is of a different frequency than the key code carrying signal to permit simultaneous transmission of both signals for faster transmission and increased security of the system. Ultimately, an evaluation unit in communication with the second receiver compares the key code with an unlocking code to determine if the key code matches the unlocking code.

### This application claims priority to Provisional Patent Application Ser. No. 60/186,643, filed Mar. 5, 2000.

### BACKGROUND OF THE INVENTION

This invention relates to a device and method for an electronic security system.

A number of electronic security systems exist that employ electromagnetic waves to lock and unlock secured areas. In particular, on motor vehicles such systems are frequently employed to lock and unlock a vehicle's doors or trunk as well as start the vehicle's ignition system. Such systems generally involve a key with a radio frequency transmitter that emits a signal carrying a key code. A receiver in the vehicle receives the signal and determines whether the key code matches an unlocking code. If the codes match, then the lock of the system is unlocked.

These systems in general may be “active” or “passive.” A passive system generally begins the transmission of signals without any specific actuation from an operator. An active system will generally transmit a signal such as when the operator actuates a switch or button. One common application of a “passive” system is in a vehicle ignition lock. When the operator inserts the key into the ignition, a lock system queries a code on the key. These systems are gaining wide popularity in vehicle applications.

These systems, however, have drawbacks. Radio frequency waves carrying key code information may be received, captured, and used by thieves to overcome vehicle security systems. Also, because the radio frequency wave transmitted by a key for such systems is typically a short burst, the transmission of a longer and more secure key code is not possible. Radio waves are also subject to interference and consequently require the receiver in the vehicle to be very selective in signal reception, increasing the possibility the system will not function optimally. The use of radio waves also prevents the simultaneous transmission of other radio frequencies that may cause signal interference. Indeed, even the proximity of metal may prevent the code carrying signal from the key from reaching the vehicle's receiver.

Systems do exist that employ optical waves to communicate the code carrying signal from transmitter to receiver. Such systems may involve a key with an optical wave transmitter that transmits key code information to a receiver in the vehicle, which then compares the key code information with an unlocking code. While these systems provide better security than radio frequency systems, such systems place a fair amount of drain on the key's battery. Accordingly, a large battery may have to be placed in the key, resulting in an undesirable size key.

A need therefore exists for a smaller and more robust security system.

### SUMMARY OF THE INVENTION

In a disclosed embodiment, the electronic security system comprises two sets of transmitters and receivers, one set is preferably on a key while another set is preferably on the area to be secured, such as motor vehicle. A first transmitter on the motor vehicle generates an energy carrying signal for a first receiver on a key. A memory unit preferably on a key is activated and at least partially powered by this energy carrying signal. The memory unit stores a key code, which upon activation, communicates the key code to a second transmitter on the key, which in turn transmits a key code carrying signal to a second receiver on the vehicle. Ultimately, an evaluation unit evaluates the transmitted and received key code to determine if the key code matches an unlocking code.

The electronic security system may further including an energy storage device on the key, such as a battery, to store energy from the energy carrying signal.

The energy carrying signal can be a radio wave, such as a low frequency (LF) wave while the key code carrying wave is preferably a light wave, such as an infrared light wave. Importantly, the energy carrying signal should be a different frequency than the key code carrying signal to avoid interference of signals. The system also permits simultaneous transmission of energy carrying signal and key code carrying signal. In such a configuration, the energy carrying signal may also carry another code to be received by memory unit to permit further encryption and security by the system. Thus, two codes safeguard the integrity of the system instead of one as with other security systems. The simultaneous transmission of both energy carrying signal and key code carrying signal also increases the speed of communication between key and car security system.

If the key code carrying signal is a light wave, then the second transmitter may be a fiber optic transmitter while the second receiver is a fiber optic receiver. The electronic security system further includes a security component, such as a lock in communication with the evaluation unit that unlocks when the key code matches the unlocking code.

Preferably, the first receiver is a transponder located on the key with the memory unit and second transmitter. The first transmitter, second receiver, and evaluation unit are then part of the motor vehicle. Additionally, an energy storage device such as a battery are part of the same key.

In all variations, energy transmits to a receiver and at least partially powers the memory unit storing the key code. The key code is then transmitted to a receiver on the area to be secured. The key code is then evaluated to determine a match with an unlocking code.

This method provides a more compact and improved security system. Specifically, in contrast to systems operating only with a single set of transmitters and receivers, the system provides an additional safeguard. To obtain the key code, one must transmit an energy carrying wave to the key and then intercept the key code transmitted from the key. When a light wave is used to transmit the key code, the prospect of key code interception is difficult by the means used to intercept radio signals. The use of such a light wave to transmit the key code further avoids the problems of radio interference from other radio wave sources in the transmission of the key code and even permits the simultaneous transmission of both light wave and radio wave to improve vehicle security and expedite unlocking of the vehicle. Moreover, unlike optical systems employed currently, the system further permits the use of a smaller battery or no battery at all for the key because the key is charged remotely. This charging feature even permits the extended transmission of the key code carrying signal, allowing for the use of longer and more secure key code to be maintained in the key.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 shows a schematic view of an embodiment of the invention as part of a key and ignition system.

FIG. 2 shows a detail view of an embodiment of the invention.

FIG. 3 shows a portion of an embodiment of the invention of FIG. 2.

### DETAILED DESCRIPTION OF THE PREFERRED EMBODIMENT

The electronic security system comprises two sets of transmitters and receivers, one set communicates an energy carrying signal while the other set communicates a key code carrying signal. A memory unit is at least partially powered by the energy carrying signal and releases the key code to be carried by the key code carrying signal. An evaluation obtains the key code and determines whether the key code matches an unlocking code. The two sets of transmitters and receivers are set at different frequencies to avoid interference and permit simultaneous transmission and reception of both signals.

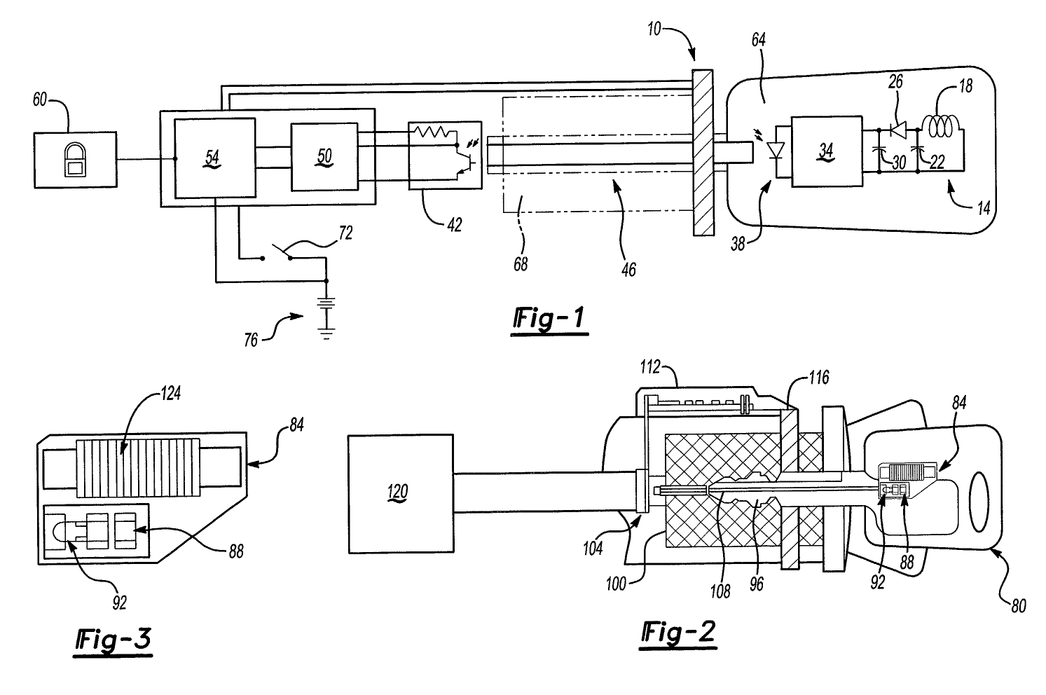

FIG. 1 illustrates a schematic embodiment of the system in the environment of a vehicle ignition. In the vehicle is first transmitter 10, preferably a radio transmitter including antenna, that generates an energy carrying signal. The energy carrying signal is preferably a low frequency radio wave. First receiver 14 is attuned to the same frequency as first transmitter 10 and communicates with this transmitter to receive the energy carrying signal. First receiver 14 can be a simple low frequency receiver such as coil 18 and capacitor 22. The energy carrying signal is then converted from an alternating current to a direct current by a device known in the art such as diode 26. The energy from the signal may be then stored on energy storage device 30, such as a battery or as illustrated here capacitor 30. Memory unit 34 is activated and is at least partially powered by the energy carrying signal. Upon powering of memory unit 34, a key code stored in memory unit 34 is communicated to second transmitter 38. The key code may be an identification code or information to be used to calculate the identification code. Second transmitter 38 generates a key code carrying signal for second receiver 42.

The key code carrying signal is preferably a light wave such as an infrared light wave. Accordingly, second transmitter 38 is preferably a fiber optic transmitter such as a light emitting diode (LED) while second receiver 42 is a fiber optic receiver. In this embodiment, the key code carrying signal is transmitted by fiber optic transmitter 38 to fiber optic receiver 42 through fiber optic channel 46, providing a secure means of communicating the key code to second receiver 42 less susceptible to interception then to the use of radio waves in current systems. The use of a light wave further avoids the problems of radio interference from other radio wave sources or metal in the transmission of the key code. Moreover, unlike optical systems, the system further permits the use of a smaller battery or no battery at all for the key because the key is charged remotely. This charging feature even permits the extended transmission of the key code carrying signal, allowing for the use of a longer and more secure key code to be maintained in the key.

Indeed, the use of an energy carrying signal (preferably low frequency) with an electromagnetic frequency different from the key code carry signal (preferably optical) permits simultaneous transmission of the energy carrying signal with the key code carrying signal. The difference in frequency need only be sufficient to avoid interference between the two signals. In this way, the system avoids interference between the two signals and accordingly permits simultaneous transmission of both energy carrying signal and key code carry signal. Such simultaneous communication allows for the faster transmission of the key code than previously provided by radio frequency transmitters/receiver systems.

Amplifier 50 receives key code carrying signal from second receiver 42 and amplifies signal for evaluation unit 54. Evaluation unit 54 then obtains and compares the key code with an unlocking code, preferably stored in its memory, to determine if the key code matches the unlocking code. If so, then evaluation unit 54 ultimately communicates with lock 60 to unlock. As known in the art, lock 60 may be a mechanical or electromechanical locking system.

As shown in FIG. 1, first receiver 14, memory unit 34, and second transmitter 38 are part of a key 64 while first transmitter 10, second receiver 42, and evaluation unit 54 are a part of a vehicle and in communication with a security component such as the vehicle's ignition lock 68. Moreover, in such an embodiment, the entire system may be triggered by actuation of the vehicle's ignition switch 72 and powered by the vehicle's battery 76.

FIG. 2 shows a detailed view of an embodiment of the present invention. Here, key 80 contains transponder 84, memory unit 88 such as a logic integrated circuit, and second transmitter 92 shown as an infrared light emitted diode. Key 80 is also a mechanical key with teeth 96 to match ignition lock cylinder 100 for additional security. Stretching between second transmitter 92 to second receiver 104 is fiber optic channel 108. In this embodiment, first transmitter 112, a low frequency transceiver, employs low frequency antenna 116 to communicate with second receiver 84, a transponder that activates upon reception of the low frequency radio signal. Energy carrying signal received by first receiver 84 activates and partially powers memory unit 88 to release its key code. A key code carrying light wave is generated by second transmitter 92, a light emitting diode, and carried through fiber optic channel 108 to second receiver 104, a fiber optic receiver. As before, evaluation unit 120 determines whether key code matches an unlocking code.

FIG. 3 shows a detail of key 80. Low frequency antenna 124 is shown with first receiver 84. Also shown are memory unit 88 and second transmitter 92. 26. The systems described by FIGS. 1-3 also permit a greater measure of security than current systems because of the use of a transmitter and receiver to communicate the energy carrying signal. Specifically, in addition to carrying energy to activate and at least partially power the memory unit, the energy carrying signal may also carry an encryption code such as a random number. In this application, referring to FIG. 1, evaluation unit 54 generates a random number and communicates this number to first receiver 14 through first transmitter 10. Memory unit 34 ultimately receives this number and processes this number with a secret algorithm, such as a numeric formula. The resulting key code is then transmitted to evaluation unit 54 through second transmitter 38 and second receiver 42. Evaluation unit 54 applies the same algorithm to the same random number. If the answer from evaluation unit 54 matches the resulting key code from memory unit 34, the system is unlocked. In this way, the key code varies randomly. Only a random number and the varying resulting code can be captured. Since evaluation unit 54 generates a random number for each transmission, any information captured would be useless to unlock the system. The transmission of this random number is only possible through the use of a transmitter and receiver to communicate the energy carrying signal.

The coding algorithms may be as known in the art. The components utilized to achieve this invention may be different from those specifically disclosed, and a worker in this art would recognize various modifications to achieve these systems. The present invention is most preferably utilized in a passive ignition lock system. The disclosed systems and methods will have application, however, in other types of passive and even active systems.

The aforementioned description is exemplary rather then limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. An electronic security system comprising:
a first transmitter generating an energy carrying signal;
a first receiver in communication with said first transmitter for receiving said energy carrying signal;
a memory unit at least partially powered by said energy carrying signal, storing a key code;
a second transmitter in communication with said memory unit, generating a key code carrying signal;
a second receiver in communication with said second transmitter for receiving said key code carrying signal; and
an evaluation unit in communication with said second receiver for comparing said key code with an unlocking code to determine if said key code matches said unlocking code.

2. The electronic security system of claim 1 further including an energy storage device in communication with said first receiver for storing energy from said energy carrying signal.

3. The electronic security system of claim 1 wherein said energy carrying signal is a radio wave.

4. The electronic security system of claim 3 wherein said key code carrying signal is a light wave.

5. The electronic security system of claim 1 wherein said energy carrying signal is a different frequency than the frequency of the key code carrying signal to permit simultaneous transmission of said energy carrying signal and said key code carrying signal.

6. The electronic security system of claim 5 wherein said energy carrying signal is a low frequency wave and said key code carrying signal is a light wave.

7. The electronic security system of claim 1 wherein said energy carrying signal transmits an encryption code.

8. The electronic security system of claim 1 wherein said second transmitter is a fiber optic transmitter.

9. The electronic security system of claim 1 wherein said second receiver is a fiber optic receiver.

10. The electronic security system of claim 1 further including a lock in communication with said evaluation unit that unlocks when said key code matches said unlocking code.

11. The electronic security system of claim 1 wherein said first receiver is a transponder.

12. The electronic security system of claim 1 wherein said first receiver, said memory unit, and said second transmitter are on a key.

13. The electronic security system of claim 1 wherein said first transmitter, said second receiver, and said evaluation unit are a part of a vehicle.

14. An electronic security system comprising:
a first transmitter generating an energy carrying signal;
a first receiver in communication with said first transmitter for receiving said energy carrying signal;
an energy storage device in communication with said first receiver for storing energy from said energy carrying signal;
a memory unit at least partially activated by said energy carrying signal, storing a key code;
a second transmitter in communication with said memory unit, generating a key code carrying signal;
a second receiver in communication with said second transmitter for receiving said key code carrying signal; and
an evaluation unit in communication with said second receiver for comparing said key code with an unlocking code to determine if said key code matches said unlocking code.

15. The electronic security system of claim 14 wherein said energy carrying signal is a radio wave.

16. The electronic security system of claim 15 wherein said key code carrying signal is light wave.

17. The electronic security system of claim 13 wherein said energy carrying signal is a different frequency than the frequency of the key code carrying signal to permit simultaneous transmission of said energy carrying signal and said key code carrying signal.

18. The electronic security system of claim 17 wherein said energy carrying signal is a low frequency wave and said key code carrying signal is a light wave.

19. The electronic security system of claim 14 wherein said energy carrying system transmits an encryption code.

20. A method of electronic security comprising the steps of:
transmitting an energy carrying wave;
receiving the energy carrying wave;
at least partially powering a memory unit that stores a key code, with energy from the energy carrying wave;
transmitting a key code carrying wave of a different frequency than said energy carrying signal;
receiving the key code carrying wave; and
evaluating the key code from the key code carrying wave to determine a match with an unlocking code.
